(19) United States
(12) Patent Application Publication
(10) Pub. No.: US 2017/0287661 A1
(43) Pub. Date: Oct. 5, 2017

(54) THREE-POSITION VACUUM SWITCH FOR REALIZING EXTERNAL GROUNDING OF LOAD SIDE BY USING BRIDGE SWITCH

(71) Applicant: SHENYANG HUADE HIGH TECHNOLOGY ELECTRIC CO., LTD., Liaoning (CN)

(72) Inventors: Jiaosuo ZHANG, Liaoning (CN); Tao CHEN, Liaoning (CN); Shizheng GUO, Liaoning (CN)

(21) Appl. No.: 15/510,237

(22) PCT Filed: Sep. 8, 2015
(86) PCT No.: PCT/CN2015/089124

§ 371 Date: Mar. 10, 2017

(30) Foreign Application Priority Data
Nov. 12, 2014 (CN) 201410632088.9

(51) Int. Cl. H01H 33/666; H01H 89/00

(52) U.S. Cl. CPC H01H 33/666; H01H 33/6664; H01H 89/00

(57) ABSTRACT

A three-position vacuum switch for realizing external grounding of a load side by using a bridge switch overcomes the problems in the prior art that load side grounding is realized depending on the opening and closing of a vacuum arc extinguishing chamber, a misoperation easily occurs because an operator cannot see the grounding situation intuitively, and when an operating mechanism machine has a problem, it needs to have a grounding line plugged in externally, which cause inconvenient operations with huge safety risks, a complicated structure and relatively high cost, characterized in that a bridge grounding switch is provided on the other side of the three-position vacuum switch to realize external grounding of the load side via the bridge grounding switch.

### BACKGROUND OF THE INVENTION

The invention belongs to the field of s pit switching technology equipment, particularly relates to a three-position vacuum switch for realizing load-side external grounding utilizing a bridge switch.

The existing vacuum switch comprises the buses, vacuum interrupter, a load conductor, a grounding conductor and a three-position switch (an isolated position, a middle position and a grounding position) and an operating mechanism. The vacuum interrupter is driven by the operating mechanism to realize the breaking of the line buses.

Patent Application Number: CN200710103519. 2. Corresponding invention patent with Application Number: US2006060273 discloses a three-position vacuum switch for providing current interruption, isolation and grounding, comprising the line buses, a vacuum interrupter, a load conductor, a grounding conductor and an operating mechanism. The vacuum interrupter comprises a static conducts, a moving conductor and an insulating cylinder, wherein, the static contacts and the moving contacts are positioned in the insulating cylinder; the moving contacts can be moved between the position where the static contacts are electrically connected to the closed circuit and the position where the static contacts are separated with the turn-off circuit; the load conductor is electrically connected to the moving conductor; the structure of operating mechanism is: (a) to realize the making and switching of circuit by contacting and breaking of moving contacts and static contacts, and (b) to move the vacuum interrupter between the first position (i.e. the circuit conducting position) and the second position (i.e. the load side grounding position), wherein, the static contacts are electrically connected to the circuit buses at the first position and the static conductor is electrically connected to the grounding conductor. Combined with its FIG. 3D, 3E, 4D and 4E, it shows that when the load-side conductor is grounding, first, the vacuum interrupter is broken, then the vacuum interrupter is rotated to the position where the static conductor and the grounding conductor are connected, and then the vacuum interrupter is switched on, to realize the load-side grounding. However, there is a problem; that the operator cannot visually see the ground situation arising from misuse because the vacuum interrupter is completely closed in load grounding process. And when there is a problem in mechanical or electrical operating mechanism, the closing grounding cannot be realized and the plug grounding wires are required, so that the operation is trouble and inconvenient with greater security risks; and combined with its FIG. 6B and 6C, it shows that the same is that the vacuum interrupter is broken first, and then the vacuum interrupter vertically downward moved to that the static conductor is connected with the grounding conductor, and then the vacuum interrupter is closed, to realize the load-side grounding, above of all having the same problems. After the static conductor is connected with the ground conductor utilizing the technical scheme, the vacuum interrupter will appear shocks when it is reclosed, to ensure that vacuum interrupter is well fixed and will not appear shock when it is closed, and the external holding device is required, but its structure is complex with high costs.

In addition, in the conventional vacuum switchgear, since the vacuum interrupter is not only to withstand the function of breaking current, but also to withstand the insulation withstand voltage function, which lead prone NSDD (non-holding disruptive discharge) phenomenon, affecting the security of the device.

### BRIEF SUMMARY OF THE INVENTION

The technical problem to be solved by the utility model is: to overcome the shortcomings and defects on the invention; to provide a three-position vacuum switch for realizing load-side external grounding utilizing a bridge switch which have the advantage of simple, low costs, high security, that the load-side external grounding process can be visually seen by the operator, and avoids the vacuum interrupter shock occurs.

The technical scheme of the utility model comprises the line bus, a vacuum interrupter, an operating mechanism and the load buses. The vacuum interrupter is driven by the operating mechanism to realize the breaking of the line buses. The vacuum interrupter rotates to realize the closing disconnection and load-side grounding. The other side of the three-position vacuum switch composing of the line buses, a vacuum interrupter, an operating mechanism and the load buses is provided with a bridge switch to realize the visual grounding of load buses by bridge switch.

The bridge switch is composed of a grounding static conductor and a rotating grounding bridge arm. The static conductor is provided with the grounding static contacts. The bridge are contacts are welded on the rotating grounding bridge arm.

The bridge grounding switch is composed of a grounding static conductor and a straight grounding bridge arm. The grounding static conductor is provided with the grounding static contacts, and the bridge arm contacts are welded on the straight grounding bridge arm.

When the static conductor contacts on the static conductor of the vacuum interrupter are positioned between the line contacts on the line buses and the grounding static contacts on the grounding static conductor, an isolation position and grounding position are formed on the three-position switch, and a visual grounding fracture is formed on the three-position switch between the static conductor contacts on the static conductor and the grounding static contacts on the grounding static conductor. The static conductor contacts on the static conductor are contacted with the grounding static contacts on the grounding static conductor, to realize the grounding closing position of the three-position switch. Driven by the bridge grounding switch driving mechanism, the rotating grounding arm on the bridge grounding switch rotates to the bridge arm contacts on the rotating grounding bridge arm around the bridge grounding switch driving points and contacted with the moving conductor contacts on the moving conductor, to realize the visual load bus side external grounding.

Driven by the switch driving mechanism with the bridge grounding switch driving point as the driving point, the straight grounding bridge arm on the bridge grounding switch moves to the bridge arm contacts on the straight bridge arm in a straight line and contacts with the moving conductor contacts on the moving conductor, to realize the visual load bus side external grounding.

The vacuum interrupter is to only withstand the breaking process. The vacuum interrupter and the insulating gas are to only jointly withstand the power frequency and lightning impulse withstand voltage after breaking.

The rotating grounding bridge arm composed of two straight bridge arms mutually perpendicular to each other and integrally.

Compared with the present invention, the invention has the beneficial effects that;

(1) The invention realizes the breaking of the main buses utilizing a vacuum interrupter breaking and switching and realizes three position switch function utilizing a rotating vacuum interrupter. In addition, the invention realizes the load-side external grounding utilizing a bridge grounding switch; realizes the operator visual grounding; to overcome the existing technology which relies on a vacuum interrupter closing to realize the load side grounding; overcomes the problem that the operator cannot visually see the ground situation arising from misuse because the vacuum interrupter is completely closed in load grounding process; it has the advantages of simple structure, easy operation, and it is safer and more reliable for closing ground than vacuum interrupter.

(2)When the operating mechanism has a mechanical or electrical failure, resulting in not grounded, the bridge switch can be manually operated utilizing the invention to realize the reliable load-side grounding.

(3) Since the grounding static contacts on the static grounding conductor of the invention has a supporting and fixation role on the vacuum interrupter on the vacuum interrupter, the holding device can be cancelled so that structure becomes simple and costs are reduced.

(4) The vacuum interrupter of the invention is to withstand only the breaking process, and the vacuum interrupter and the insulating gas are to only jointly withstand the power frequency and lightning impulse withstand voltage after breaking, greatly reducing the probability of NSDD (non-holding disruptive discharge) phenomenon.

### BRIEF DESCRIPTION OF THE DRAWINGS

FIG. 1 is a diagram of the line conducting structure of the invention;

FIG. 2 is a top view of FIG. 1;

FIG. 3 is a diagram of the lines of the invention in breaking and in the isolated closing position;

FIG. 4 is a diagram of the lines of the invention in breaking and in the middle position (isolated position, grounding position);

FIG. 5 is a diagram of the lines of the invention in breaking and in the grounding closing position;

FIG. 6 is a diagram of the lines of the invention in breaking and in the grounding position and in the load grounding.

FIG. 7 is a diagram of another embodiment of the invention of the line breaking, grounding and grounding in the load diagram.

As shown in FIGS:

1. Line bus; 1-1. Line contacts;

2. Vacuum interrupter;

2-1. Static conductor; 2-1-1. Static conductor contacts;

2-2. Static contacts;

2-3. Moving conductor; 2-3-1. Moving conductor contacts;

2-4. Moving contacts;

2-5. Insulating cylinder;

2-6. Static cover;

2-7. Moving cover;

2-8. Bellows,

3. Operating mechanism;

4. Bridge grounding switch;

4-1. Static grounding conductor; 4-1-1 Ground static contacts;

4-2a. Rotating grounding bridge arm;

4-2b. Straight grounding bridge arm:

4-2-1. Bridge arm contacts;

5. Load buses;

6. Bridge grounding switch driving point.

### DETAILED DESCRIPTION OF THE INVENTION

The embodiments of the invention are given in FIGS.

Embodiment 1

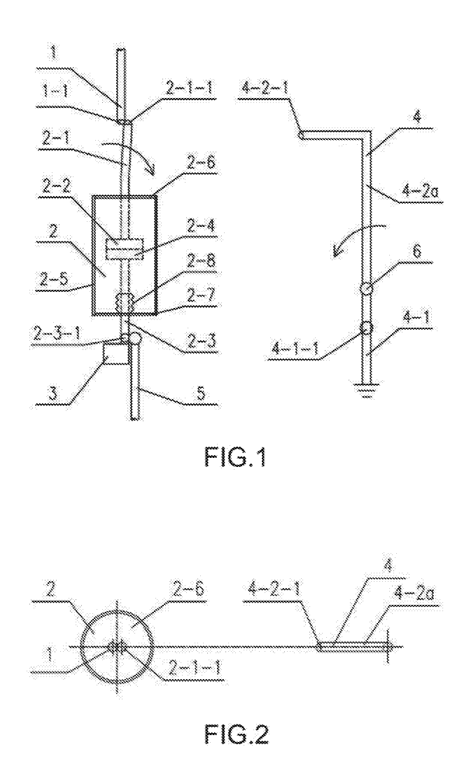

As shown in FIG. 1 and FIG. 2, the invention comprises the line buses 1, a vacuum interrupter 2, an operating mechanism 3 and the load buses 5; the line buses are provided with line contacts 1-1; the vacuum interrupter 2 is composed of a moving conductor 2-3 and the moving contacts 2-4, a static conductor 2-1, a static contact 2-2, an insulation tube 2-5, a static cover 2-6, a moving cover 2-7, and bellows 2-8; the static conductor 2-1 is provided with the static conductor contacts 2-1-1; the moving conductor 2-3 and the moving contacts 2-4 are welded into a whole, and the part of moving conductor 2-3 is exposed outside the insulating cylinder 2-5; the moving conductor contacts 2-3-1 are welded at the top of the section outside the insulating cylinder 2-5 exposed to the moving conductor 2-3; the section of the moving conductor 2-3 welded with the moving contacts 2-4 is positioned in the insulating cylinder 2-5; the moving cover 2-7 is welded at the lower end of the insulating cylinder 2-5; also the bellow 2-8 are welded between the moving cover 2-7 and the moving conductor 2-3 to form a sealing structure; the static conductor 2-1 and the static contacts 2-2 are welded into a whole; and the part of the static conductor 2 is exposed outside the insulating cylinder 2-5; the static conductor contacts 2-1-1 are welded at the top of the section outside the insulating cylinder 2-5 exposed to the static conductor 2-1; the section of static conductor 2-1 welded with the static contacts 2-2 is positioned in the sealing insulating cylinder 2-5; the static cover 2-6 is welded at the upper end of the insulating cylinder 2-5; the static conductor 2-1 is welded on the central bore of the static cover 2-6 to form a sealing structure; the insulating cylinder 2-5 is in vacuum state when using; the moving contacts 2-4 move in the insulating cylinder 2-5 in a straight line driven by the moving conductor 2-3, to realize line breaking and conducting; the other side of the three-position vacuum switch composing of the bus line 1, the vacuum interrupter 2, the operating mechanism 3 and 5 load bus is provided with the bridge grounding switch 4; the bridge grounding switch 4 is composed of a grounding static conductor 4-1 and rotating grounding bridge arm 4-2a; the grounding static conductor 4-1 is provided with the grounding static contacts 4-1-1; the rotating grounding bridge arm 4-2a is composed by two straight-line bridge arms vertical to each other and welded into a whole; the bridge arm contacts 4-2-1 are welded on the rotating grounding bridge arm 4-2a; the bridge ground in switch driving points 6 are provided between the grounding static conductor 4-1 and the rotating grounding bridge arm 4-2a.

As shown in FIG. 4, an isolating fracture is formed on the three-position switch between the line contacts 1-1 on the line buses 1 and the static conductor contacts 2-1-1 on the static conductor 2-1; when the static conductor contacts 2-1-1 on the static conductor 2-1 are positioned between the line contacts 1-1 on the line buses 1 and the grounding static contacts 4-1-1 on the grounding static conductor 4-1, a middle position (i.e. an isolation position and a grounding position) is formed on the three-position switch; a visual grounding fracture is formed on the three-position switch between the, static conductor contacts 2-1-1 on the static conductor 2-1 and the grounding static contacts 4-1-1 on the grounding static conductor 4-1.

As shown in FIG. 5, the static conductor contacts 2-1-1 on the static conductor 2-1 are contacted with the grounding static contacts 4-1-1 on the grounding static conductor 4-1, to realize the grounding closing position of the three-position switch; meanwhile, the grounding static contacts 4-1-1 on the grounding static conductor 4-1 has a fixation role on the vacuum interrupter 2.

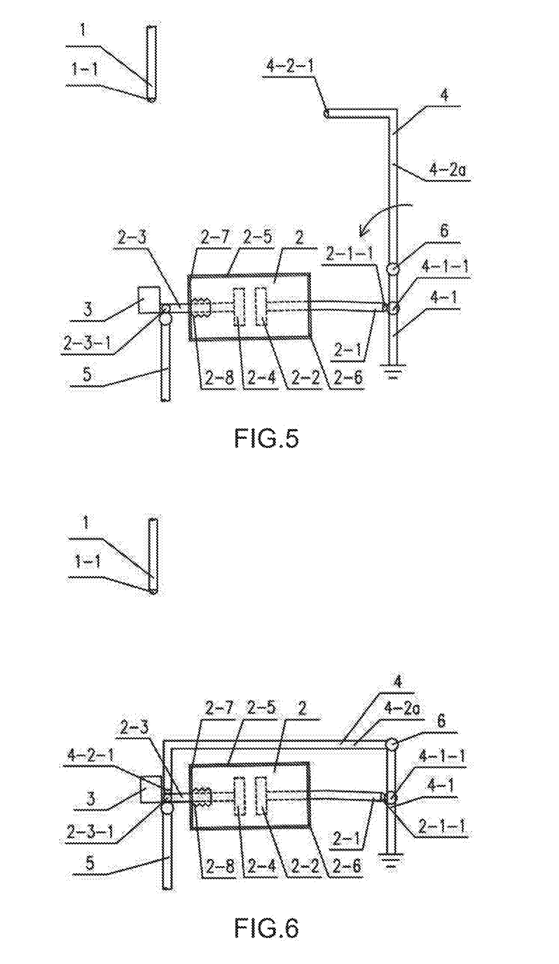

As shown in FIG. 6, driven by the switch driving mechanism, the rotating grounding arm 4-2a on the bridge grounding switch 4 rotates to the bridge arm contacts 4-2-1 on the rotating grounding bridge arm 4-2a around the bridge grounding switch driving points 6, to realize the visual load bus side external grounding 5.

The vacuum interrupter is to only withstand the breaking process. The vacuum interrupter and the insulating gas are to only jointly withstand the power frequency and lightning impulse withstand voltage after breaking.

Utilizing procedures are described as below:

Step 1 in FIG. 1 shows line conducting state; the vacuum interrupter 2 in the closing position, the line contacts 1-1 on the line buses 1 are contacted with the static conductor contacts 2-1-1 on the and static conductor 2-1, to realize the three-position switch isolating and closing position;

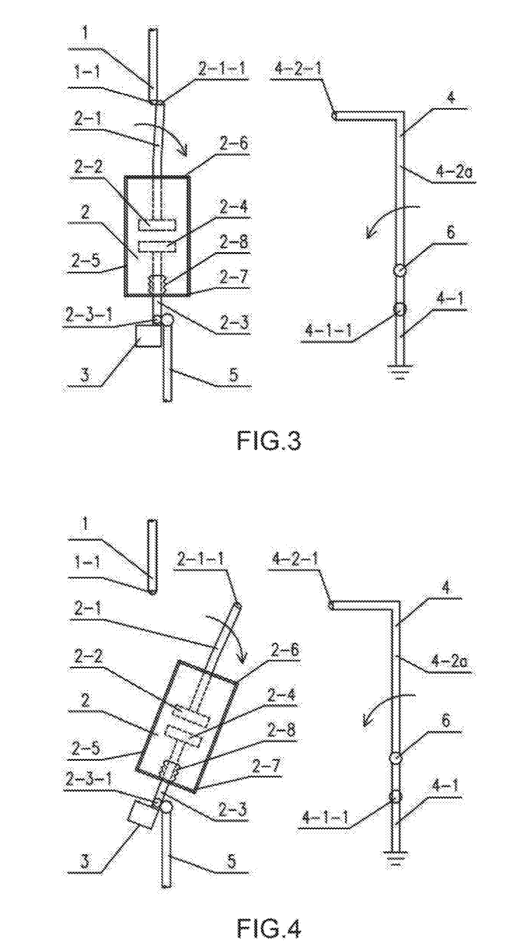

Step 2 in FIG. 3 shows a line breaking state; the moving conductor 2-3 moves driven by the moving conductor 2-3, to realize the vacuum interrupter 2 breaking, so that the lines are in breaking; the load buses 5 is not charged, three-position switch is still in the isolating and closing position;

Step 3 in FIG. 4 shows a line breaking state, the operating mechanism 3 rotates to the middle position driven by the vacuum interrupter 2, then the vacuum interrupter 2 is still in position, while the line contacts 1-1 on the line buses 1 is separated from the static conductor contacts 2-1-1 on the static conductor 2-1, to realize the three-position switch isolation and position, that is middle position, also is the grounding position, forming a significant fracture to improve is security;

Step 4 FIG. 5 shows a line breaking state 4, the operating mechanism 3 rotates to the static conductor contacts 2-1-1 on the static conductor 2-1 driven by the vacuum interrupter 2 and contacted with the grounding static contacts 4-1-1 on the grounding conductor 4-1, to realize the grounding closing position of the three-position switch; meanwhile, the grounding static contacts 4-1-1 on the grounding static conductor 4-1 has a fixation role on the vacuum interrupter 2.

Step 5 in FIG. 6 shows a line breaking state; then the vacuum interrupter 2 is still in position; the three-position switch is in the grounding closing position ; driven by the bridge grounding switch driving mechanism, the rotating grounding arm 4-2a on the bridge grounding switch 4 rotates to the bridge arm contacts 4-2-1 on the rotating grounding bridge arm 4-2a around the bridge grounding switch driving points 6 and contacted with the moving conductor contacts 2-3-1 on the moving conductor 2-3, to realize the load bus 5 side external grounding; the rotating grounding bridge arm 4-2a is positioned outside the vacuum interrupter 2, and its closing or breaking can be visually seen by the operator, so that the equipment operation is more convenient with higher safety factor; meanwhile, the grounding static contacts 4-1-1 on the grounding static conductor 4-1 has a fixation role on the vacuum interrupter 2. So the vacuum interrupter 2 will not appear shocks when it is broken and closed, so that the invention is safer and more reliable and its structure simple.

Embodiment 2

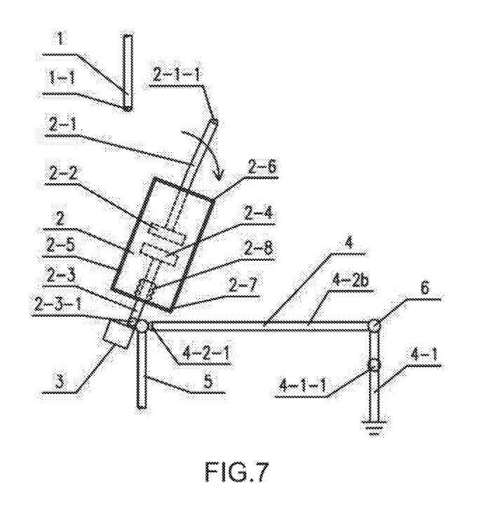

As shown in FIG. 7, same as specific embodiment 1, the differences are that the bridge grounding switch 4 is composed of the grounding static conductor 4-1 and the straight grounding bridge arm 4-2b; the bridge arm contacts 4-2-1 are welded on the straight grounding bridge arm 4-2b; FIG. 7 shows a line breaking state; at this time, the vacuum interrupter 2 is in position; three-position switch is in the isolation position (i.e. the middle position; driven by the switch driving mechanism with the bridge grounding switch driving point 6 as the driving point, the straight grounding bridge arm 4-2b on the bridge grounding switch 4 moves to the bridge arm contacts 4-2-1 on the straight bridge arm 4-2b in a straight line and contacts with the moving conductor contacts 2-3-1 on the moving conductor 2-3, to realize the visual load bus 5 side external grounding; the rotating grounding bridge arm 4-2b is positioned outside the vacuum interrupter 2, and its dosing or breaking can be visually seen by the operator, so that the equipment operation is more convenient with higher safety factor; meanwhile, the grounding static contacts 4-1-1 on the grounding static conductor 4-1 has a fixation role on the vacuum interrupter 2. So the vacuum interrupter 2 will not appear shocks when it is broken and dosed, so that the invention is safe and reliable and its structure is simple.

The line bus 1, line contacts 1-1, static conductor 2-1 and static conductor contact 2-1-1, static contacts 2-2, moving conductor 2-3, moving contact 2-4, bridge grounding switch 4 and load bus 5 are all good load bus conductors.

What is claimed is:

1. A three-position vacuum switch for realizing load-side external grounding utilizing a bridge switch comprising the line buses (1), a vacuum interrupter (2), an operating mechanism (3) and the load buses (5), wherein the vacuum interrupter (1) is driven by the operating mechanism (3) to realize the breaking of the line buses (1), and the vacuum interrupter (2) rotates to realize the closing disconnection and load-side grounding, is characterized in that: the other side of the three-position vacuum switch composing of the line buses (1), a vacuum interrupter (2), an operating mechanism (3) and the load buses (5) is provided with a bridge switch (4) to realize the visual grounding of load buses (5) by bridge switch.

2. A three-position vacuum switch for realizing load-side external grounding utilizing a bridge switch of claim 1 is characterized in that: The bridge switch (4) is composed of a grounding static conductor (4-1) and a rotating grounding bridge arm (4-2a); the static conductor (4-1) is provided with the grounding static contacts (4-1-1); the bridge arm contacts (4-2-1) are welded on the rotating grounding bridge arm (4-2a).

3. A three-position vacuum switch for realizing load-side external grounding utilizing a bridge switch of claim 1 is characterized in that: The bridge grounding switch (4) is composed of a grounding static conductor (4-1) and a straight grounding bridge arm (4-2b); the grounding static conductor (4-1-1) is provided with the grounding static contacts (4-1-1), and the bridge arm contacts (4-2-1) are welded on the straight grounding bridge arm (4-2b).

4. A three-position vacuum switch for realizing load-side external grounding utilizing a bridge switch of claim 2 is characterized in that: When the static conductor contacts (2-1-1) on the static conductor (2-1) of the vacuum interrupter (2) are positioned between the line contacts (1-1) on the line buses (1) and the grounding static contacts (4-1-1) on the grounding static conductor (4-1), an isolation position and a grounding position are formed on the three-position switch, and a visual grounding fracture is formed on the three-position switch between the static conductor contacts (2-1-1) on the static conductor (2-1) and the grounding static contacts (4-1-1) on the grounding static conductor (4-1); the static conductor contacts (2-1-1) on the static conductor (2-1) are contacted with the grounding static contacts (4-1-1) on the wounding static conductor (4-1), to realize the grounding closing position of the three-position switch; driven by the bridge grounding switch driving mechanism, the rotating grounding arm (4-2a) on the bridge grounding switch (4) rotates to the bridge arm contacts (4-2-1) on the rotating grounding bridge arm (4-2a) around the bridge grounding switch driving points (6) and contacted with the moving conductor contacts (2-3-1) on the moving conductor (2-3), to realize the visual load bus (5) side external grounding.

5. A three-position vacuum switch for realizing load-side external grounding utilizing a bridge switch of claim 3 is characterized that: driven by the switch driving mechanism with the bridge grounding switch driving point (6) as the driving point, the straight grounding bridge arm (4-2b) on the bridge grounding switch (4) moves to the bridge arm contacts (4-2-1) on the straight bridge arm (4-2b) in a straight line and contacts with the moving conductor contacts (2-3-1) on the moving conductor (2-3), to realize the visual load bus (5) side external grounding.

6. The three-position vacuum switch for realizing load-side external grounding utilizing a bridge switch of claim 4 is characterized in that: The vacuum interrupter (2) is to only withstand the breaking process; the vacuum interrupter (2) and the insulating gas are to only jointly withstand the power frequency and lightning impulse withstand voltage after breaking.

7. The three-position vacuum switch for realizing load-side external grounding utilizing a bridge switch of claim 2 is characterized in that: The rotating grounding bridge arm (4-2a) is composed of two straight bridge arms mutually perpendicular to each other and integrally.
